(19) United States
(12) Patent Application Publication
(10) Pub. No.: US 2014/0263376 A1
(43) Pub. Date: Sep. 18, 2014

(54) Accumulator Insert for Use With A Composite Sampling System

(71) Applicant: Mustang Sampling, LLC, Ravenswood, WV (US)

(72) Inventor: Claude A. Rolston, St. Marys, WV (US)

(73) Assignee: Mustang Sampling, LLC, Ravenswood, WV (US)

(21) Appl. No.: 14/210,653

(22) Filed: Mar. 14, 2014

Related U.S. Application Data
(60) Provisional application No. 61/794,240, filed on Mar. 15, 2013.

(51) Int. Cl. B01L 3/12; F17C 13/00

(52) U.S. Cl. CPC B01L 3/12; F17C 13/00
USPC 220/694; 53/467

(57) ABSTRACT

Provided is a precisely sized, inert, non-corrosive volumetric insert for a composite gas accumulator dimensionally conforming to the cross-sectional area of the accumulator and having gas mixing channels where one or more of the inserts is deployable to reduce the interior volume of composite gas accumulator for composite sample collection from transfer processing of smaller LNG transport vehicles whereby a standard size accumulator system can be used without the need to maintain extremely high gas pressure to prevent Joule-Thompson condensation.

### FIELD OF INVENTION

This invention relates to adjunct devices and methods for reducing the volume of a sample collection cylinder for gas samples and particularly for collecting composite samples of conditioned vaporized liquid natural gas obtained in a transfer process from a relatively smaller LNG transport sources.

### BACKGROUND

Liquid natural gas sampling is governed by the standard ISO 8943 and the GIIGNL LNG custody transfer handbook. Europe and other areas of the world impose additional requirements such as mandating composite sampling of transferred LNG contents, and particularly, that from ship off-loading and the sample is stable. The standard calls for a composite sampling to be collected for the duration of time a ship is off-loading for content energy auditing purposes. In such practices, the composite gas sample obtained during the transfer process is typically transferred from an accumulator to small cylinder sample containers. One or more of the small sample cylinders can be used for on-site or remote comparative analysis to the continuous analysis averages obtained online during the transfer/loadout operation. In the event of future needs, one or more of the sample cylinders may be archived for future analysis.

It is well known that the growth in the LNG industry for the past decade has been relentless. Conventionally, LNG has been transported and transferred to or from large trans-oceanic vessels. Typically composite type sample systems are employed in parallel with on-line real-time analysis from LNG vaporizers at ship loading terminals. But that may not be the final transfer operation involving the LNG. Subsequent to ship on/off loading, LNG may be subject to further transport and smaller transfer operations. For example, LNG may be transported from a coastal terminal to many destinations in different environments by smaller vessels such as inland waterway ships, barges, railcars and even tractor trailer tanker trucks. Regardless of the many forms of vehicular LNG transport, the selection typically is dictated by the characteristics of the ultimate vehicle destination, it remains generally desirable to use sample systems for energy content audits even when involving smaller vessels.

Coastal terminal equipment is properly sized for its purpose—having a scale consistent with large, trans-oceanic LNG transport. Such a scale, however, is too great for composite sampling involved in smaller transfer operations. In the case of large ship transfer, a sufficient volume of sample gas is obtained to maintain the gas pressure at a level to prevent dew point dropout due to Joule-Thompson condensation in an associated composite sample accumulator. Such dew point dropout adversely impacts the content of the composite sample and consequently, the accuracy of the eventual analysis. Therefore, the sampled gas in the accumulator is maintained at a pressure to avoid such drop out typically in association with a pump.

Smaller operations, accordingly, have the choice of foregoing composite sampling, modifying or replacing the standard equipment by, for example, swapping out the standard volume accumulator for a suitably sized, smaller accumulator, substituting the entire system with a smaller system, or subjecting the lesser gas volume in the standard sized accumulator to higher pressures. Not only do such prospects involve risk, considerable labor, and/or capital expense but also a system possessing substitute, differently sized components may require re-certification and/or regulatory inspection/approval before use. Furthermore, where substituting components is contemplated, if the system is intended to be used with a variety of transport vehicles, the user will be compelled to inventory an array of different, smaller-sized, composite sample accumulators tasked for a respective specific transport vehicle. A sample accumulator intended for transfer processing of LNG from a barge will require a larger volume than that employed in the case of a railcar transfer, for example.

Construction and substitution for a full-scale composite sample system with a scaled-down version, while appropriate to a specific target vehicle class is limited to transfer processing from that particular vehicle class (or volume equivalent). The limited scope of use of such a scaled down system, in addition to requiring its own certification and inspection, increases the transfer operator's costs by unnecessarily requiring redundant systems.

Therefore, a need exists for an alternative approach to system redesign that permits effective utilization of a standard composite sampling system using a standard accumulator.

### SUMMARY OF INVENTION

It is an object of the present invention to provide a relatively inexpensive and effective expedient for reconfiguring a composite system accumulator to correspond to the scale of the particular vessel size.

Another object of the invention is to reduce the cost of equipment and labor associated with composite sample collection of LNG.

These and other objects are satisfied by a composite gas sample accumulator adjunct for reducing the volume thereof in a composite sample system, comprising an insert formed from a pressure resistant material that is non-reactive with the sampled gas, said insert corresponding to a precise volume and having cross-sectional dimensions corresponding to the interior of the composite gas sample accumulator in a composite gas sample collection system.

Still other objects are satisfied by a method of reducing the volume in an composite gas sample accumulator to accommodate smaller volumes, comprising the steps of opening the accumulator to access the interior thereof; placing at least one insert formed of a non-reactive material and dimensioned to correspond to the interior cross-section of the accumulator and representing a precise volume; sealing the accumulator containing the insert; generating a composite gas sample in said accumulator for subsequent analysis while maintaining the gas pressure at a level sufficient to prevent dew point drop out; and transferring the composite gas sample to a sample cylinder.

An exemplary composite sample system contemplating use of the present invention is described and disclosed in commonly-owned patent application Ser. No. 14/205,526, filed on Mar. 12, 2014, the content of which is incorporated herein by reference in its entirety. That system is engineered to take timed samples from a gas input gas during offloading or transfer processing directly, intermittently, and/or as a composite. In the case of a composite, sequentially obtained sample, the accumulated gas is maintained under sufficient pressure to prevent Joules-Thompson condensation in a composite accumulator rated for the system. Following completion of the transfer operations, the collected composite sample in the accumulator is transferred to 500 cc sample cylinders and any residual gas in the accumulator and system can be vented to a BOG (boil off gas) system. The sequence of valve operation is automated during the transfer process and semi-manual operation for the sample cylinder filling and purging to empty operations.

This invention effectively allows the user to customize the accumulator volume to correspond to a particular transfer operation. The volume is reduced by introducing one or more stacked, non-reactive, non-deteriorating precisely dimensioned inserts into the accumulator interior. When dimensioned to correspond to a fractional accumulator volume (e.g. 20%) the accumulator interior volume can be reduced by as much as 80% by stacking four inserts in the accumulator. Incorporated with gas channels, the insert(s) also serve to promote gas mixing and avoid dead spaces in the reduced volume accumulator interior.

For definitional purposes and as used herein “connected” includes physical, whether direct or indirect, permanently affixed or adjustably mounted, as for example, the accumulator is connected to the composite gas sample system. Thus, unless specified, “connected” is intended to embrace any operationally functional connection.

As used herein “substantially,” “generally,” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawing, and which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWINGS

FIG. 1 is a schematic assembly side view of a composite sample gas accumulator with accumulator plug inserts according to an embodiment of the invention.

FIG. 2 is a top view of one of the accumulator plug inserts of FIG. 1.

FIG. 3 is a bottom view of the accumulator plug insert of FIG. 2.

FIG. 4 is a diagrammatic side view of the accumulator plug insert of FIG. 2.

FIG. 5 is a top cross-sectional view of the accumulator of FIG. 1 as secured by a mounting bracket.

### DETAILED DESCRIPTION

FIG. 1 depicts a generally cylindrical stainless steel accumulator 1 with a removably sealable top cap 2 having a gas inlet port 3 secured to the upper opening of the accumulator body. The bottom of the accumulator 1 features a corresponding bottom opening and is sealed with removable cap 4 featuring a gas outlet port 5. O-rings 6 are employed to enhance sealing of the caps 2 and 4 with the body of accumulator 1.

The interior of the accumulator 1 includes a chamber 7 for accumulation of gas samples introduced through the inlet 3. The chamber 7 is established by the interior stainless steel walls of the accumulator 1 and possesses a uniform cross-sectional dimension (preferably in the case of a tubular cylinder, a uniform diameter). As illustrated in FIG. 1, the chamber 7 is filled with four stacked precisely machined, stainless-steel accumulator filler plugs 10 sized to snuggly slide and nest within the interior of the accumulator 1. In the case of a 5 liter accumulator volume, each of the inserts will correspond to 1 liter. FIG. 1 depicts the volume of the chamber 7 having been reduced by 80%. Lesser reductions are realized by using fewer inserts. Where each insert corresponds to a precise, predetermined fractional amount of the accumulator volume as the need arises. That is, when a small but not so small gas volume is being sampled the accumulator chamber volume is reduced 1 liter or 20% for each insert deployed.

Turning to 2 through 4, they detail the structure of the stainless steel insert 10. The insert features arcuate side wall 12 a top surface 14 and a central bore 16 extending through the cylinder axis. The upper segment 24 of the bore 16 is threaded to permit releasable engagement of the insert 10 with a correspondingly threaded insertion rod (not shown). The bottom 18 of the insert 10 features the opening of the bore 16 to a beveled annulus 20 and a plurality of kerfs 22 that extend across the entire diameter of the bottom surface 18 from the side wall through the beveled opening 20 to the opposite side wall. The combination of the open axial bore 16 the beveled annulus 20 and the kerfs 22 establish gas mixing channels. The integrated gas mixing channels promote interior circulation of accumulated gas samples, reduce the presence of stagnant gas, and facilitate communication of the accumulated gas to the outlet 5 during filling of 500 cc sample cylinders.

FIG. 5 illustrates a typical clamping arrangement for the accumulator in the associated system housing. The accumulator 1 is securely in a aperture formed by two mating jaws 30 that are mounted under compression by bracket 32 to a system container wall 34.

Moving to use of the illustrated embodiment, in the case of offloading smaller loads with substantially less gas sampling accumulation, the volume of the accumulator is reduced by introduction of an insert. To place the insert 10 in the accumulator, the cap 2 is removed to expose the chamber 7. An elongated steel placement rod is threaded into the segment 24 of the insert 10 and once removably secured thereto, the insert 10 is lowered into the chamber 7. The placement rod is unscrewed from the insert and pulled from the accumulator. A select number of additional inserts may be placed in the accumulator in the same manner as required to maintain sufficient interior pressure to prevent dew point drop out in the accumulator. In this fashion, the inserts serve to dispense with the need for and risk of using very high pressures that are otherwise required in unmodified accumulator to prevent such drop out. After the desired number of inserts are introduced, the cap 2 is then secured to seal the accumulator chamber for composite sample accumulation.

Each plug is precisely machined, stainless-steel to fill a specific volume, e.g., 1 liter, of the accumulator. The accumulator filler plug dimensioned to fit within the interior of an associated accumulator. When the need arises such is the case of off-loading a small vessel rather than a large tanker ship, use of one or more filler plugs permits more precise and consistent sample accumulation. In this case the bottom surface includes small kerfs or cutouts to facilitate gas mixing inside the accumulator.

Although only a single embodiment of the invention has been disclosed in the forgoing specification, it is understood by those skilled in the art that many modifications and embodiments of the invention will come to mind to which the invention pertains, having benefit of the teaching presented in the foregoing description and associated drawing. It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

I claim:

1. A composite gas sample accumulator adjunct for reducing the volume thereof in a composite sample system comprising:
an insert formed from a pressure resistant material that is non-reactive with the sampled gas, said insert corresponding to a precise volume and having cross-sectional dimensions corresponding to the interior of the composite gas sample accumulator in a composite gas sample collection system.

2. The adjunct of claim 1 where the precise volume corresponds to 20% of the accumulator.

3. The adjunct of claim 1 where the non-reactive material is stainless steel.

4. The adjunct of claim 3 further including at least one gas communication channel.

5. The adjunct of claim 4 where the insert has a top and bottom surface and further comprising a bore extending axially from the top to the bottom surface and at least one integrated diametric kerf formed one the bottom surface.

6. The adjunct of claim 5 further comprising an annular beveled disposed at the intersection of the kerf and the bore.

7. The adjunct of claim 3 further incorporating a second diametric kerf in the lower surface that intersects the at least one kerf at the bore to promote gas mixing in the accumulator.

8. The method of reducing the volume in an composite gas sample accumulator to accommodate smaller volumes, comprising the steps of:
opening the accumulator to access the interior thereof;
placing at least one insert formed of a non-reactive material and dimensioned to correspond to the interior cross-section of the accumulator and representing a precise volume;
sealing the accumulator containing the insert;
generating a composite gas sample in said accumulator for subsequent analysis while maintaining the gas pressure at a level sufficient to prevent dew point drop out; and
transferring the composite gas sample to a sample cylinder.
